(19) United States
(12) Patent Application Publication
(10) Pub. No.: US 2014/0184513 A1
(43) Pub. Date: Jul. 3, 2014

(54) SOFTKEY MAGNIFICATION ON TOUCH SCREEN

(71) Applicant: NVIDIA CORPORATION, Santa Clara, CA (US)

(72) Inventors: Xianpeng Huang, Suzhou City (CN); Qiang Chen, ShenZhen City (CN); Zhi Tan, ShenZhen City (CN)

(73) Assignee: NVIDIA CORPORATION, Santa Clara, CA (US)

(21) Appl. No.: 13/731,745

(22) Filed: Dec. 31, 2012

(51) Int. Cl. G06F 3/041; G06F 3/02

(52) U.S. Cl. CPC G06F 3/041; G06F 3/02
USPC 345/168; 345/173

(57) ABSTRACT

A mobile computing device comprising a noncontact location sensor operable to detect the presence of an input object that enters a detectable region proximate to the touch screen panel. The sensor can produce location signals representing the location of the input means relative to a plurality of virtual input characters. Based on the location signals, a target virtual character can be identified and magnified to a more recognizable and accessible size before a user makes an input selection. Optionally, a series of virtual characters adjacent to the target character may also be magnified to facilitate the user to locate the desired character and improve user input accuracy. The noncontact location sensor may comprise an infrared location sensor, an optical sensor, a magnetic sensor or a combination thereof.

### TECHNICAL FIELD

The present disclosure relates generally to the field of computing devices, and more specifically to the field of touch screen enabled displays.

### BACKGROUND

Touch screens have gained increasing popularity in computer systems and particularly in mobile computing devices, such as laptops, PDAs, media players, touchpads, smartphones, etc. Users can enter selected characters by touching an intended character included in a virtual keyboard or other virtual input table that may be displayed on a touch screen. However, as consumers' demand for device portability has continuously driven size reduction in mobile device designs, available areas for displaying virtual input tables on such devices have increasingly become limited, as screen sizes shrink.

Conventionally, input characters on a virtual keyboard, or soft keys, usually remain in fixed sizes during a user selection process. FIG. 1 illustrates a screen shot of a virtual keyboard 101 having the input characters 102 of a uniform size in accordance with the prior art. Typically, the size can be smaller than a user's finger tip. The small sizes of the input characters usually make it difficult for a user to locate an intended character quickly and even more difficult to pinpoint the intended character to make an accurate selection by using a finger tip or a stylus, leading to frequent input errors which require equally frequent and repeated operation of deletion and selection. Importantly, users often find this process annoying, frustrating and time consuming.

This issue is more prominent when a user attempts to type in a security code or a password through a touch screen, during which situations the entered characters are usually concealed and so the user is unable to visually identify a typing error immediately following the entry. One approach to address this issue is to display the last entered character in the input area. However, this approach tends to defeat the purpose of security as the entered characters may be visible to an uninvited reader.

### SUMMARY OF THE INVENTION

Therefore, it would be advantageous to provide a touch screen input mechanism that improves accuracy and efficiency of user input from a virtual keyboard or virtual input “array”.

Accordingly, embodiments of the present disclosure provide a mechanism to facilitate a user to locate and enter an intended character from a virtual input array as a user input. Embodiments of the present disclosure employ a location sensor coupled with a touch screen and a processor, and the location sensor is capable of detecting the presence and location of an approaching input object (user finger, for instance) with respect to a virtual input array. In response, one or more input characters on a virtual input array that are most proximate to the approaching input object are identified and advantageously magnified before the input object touches and selects an input character from the virtual input array on the touch screen. This facilitates selection of the proper input character.

In one embodiment of present disclosure, a computing device comprises a processor, a memory that stores a program having a Graphic User Interface (GUI), a touch screen panel and a noncontact location sensor coupled with the processor. The noncontact location sensor is operable to detect the presence of an input means that enters a detectable region proximate to the touch screen panel. The GUI is configured to display a virtual input array that comprises a plurality of input selections arranged in a pattern. The computing device is further configured to 1) determine a location of the input means with respect to the input selections on the virtual input array, 2) identify an intended input selection based on the location of the input means, and 3) the GUI is configured for magnifying the intended input selection to a first magnified dimension. The intended input selection may be identified as the one most proximate to the input means. A plurality of surrounding input selections may be magnified as well and by a lesser amount. The noncontact location sensor may comprise an infrared location sensor, an optical sensor, and a magnetic sensor. The detectable region may be user programmable and in one example may approximately 20 mm above the touch screen panel.

In another embodiment of present disclosure, a method of providing input to a computing device through a touch screen panel comprises 1) displaying a virtual input region including a plurality of input characters in a first size; 2) detecting presence of a user input object approaching the touch screen panel; 3) determining distances between the user input object and the plurality of input characters, 4) identify an intended character responsive to the distances; 5) magnify the intended character as identified to a first level upon the input object being within a threshold detectable distance from the touch screen panel. The method may further comprise identifying a first set and a second set of surrounding characters and magnify them to a second level and a third level, respectively. The first level may be greater than the second level and the second level may be greater than the third level. Moreover, the method may further comprise diminishing in size another plurality of characters that are arranged distant from the intended character. The input characters may be restored to original size following a user input.

In another embodiment of present disclosure, a mobile computing device comprises a processor, a memory that is coupled with the processor and stores instructions for implementing a virtual keyboard GUI. The device also includes a touch screen display panel, and a distance sensor in association with control logic that coupled with the processor. The distance sensor is configured to detect the presence of a user digit proximate to the touch screen panel as the user digit approaches the panel. The GUI is configured to determine a location of the user digit relative to the input characters, and magnify a set of input characters that are most proximate to the user digit once the user digit enters a non-zero detectable distance from the touch screen panel. The distance sensor may comprise a plurality of thermal sensors configured to sense the heat released from a user digit. The set of input characters may be magnified by different amounts, depending on a respective distance between the user digit and each of the set of input characters. The non-zero detectable distance from the touch screen display may be approximately 20 mm.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an on-screen virtual keyboard having the input characters of a uniform size displayed on a mobile computing device in accordance with the prior art.

FIG. 2A illustrates an exemplary configuration of a mobile computing device employing a series of noncontact location sensors to detect a location of an approaching user's finger and selectively magnify a series of virtual input characters in accordance with an embodiment of the present disclosure.

FIG. 2B illustrates a Graphic User Interface (GUI) including selectively magnified input characters in a virtual keyboard in response to detection of an approaching finger in accordance with an embodiment of the present disclosure.

FIG. 3 is a flow diagram depicting an exemplary computer implemented method of entering input characters on a virtual keyboard in accordance with an embodiment of the present disclosure.

FIG. 4 is a block diagram illustrating an exemplary configuration of a mobile computing device that comprises a noncontact location sensor to facilitate user input on a virtual keyboard in accordance with an embodiment of the present disclosure.

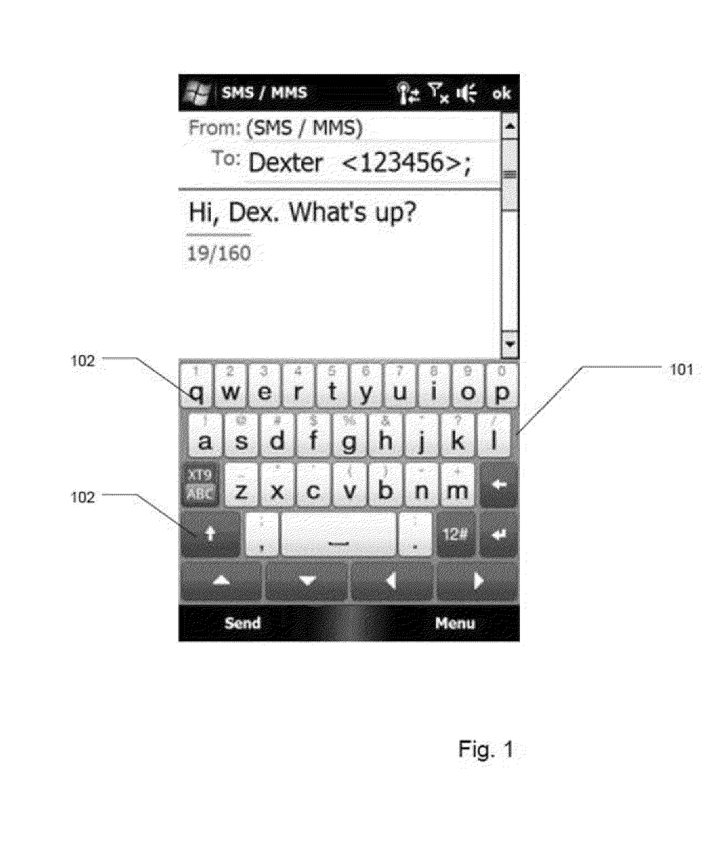

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Softkey Magnification on Touch Screen

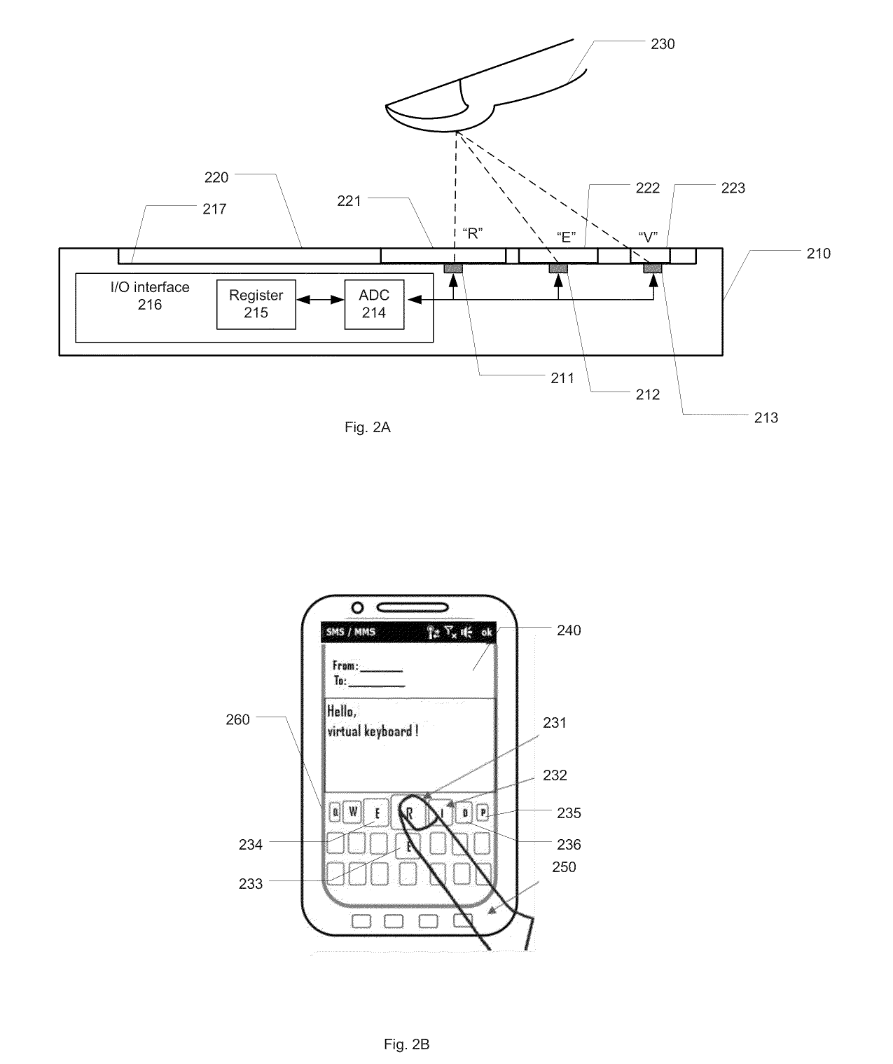

FIG. 2A illustrates an exemplary configuration of a mobile computing device 210 employing a plurality of noncontact location sensors, e.g. 211, to detect a location of an approaching finger 230 and selectively magnify a series of on-screen virtual input characters in accordance with an embodiment of the present disclosure. The mobile device 210 comprises a touch screen display panel 217 and a set of location sensors, e.g. 211, 212 and 213, coupled with an Input/Output (I/O) interface 216.

According this embodiment, an on-screen GUI can be displayed on the touch screen 217 and define a data receiving area 220 and a virtual keyboard (not explicitly shown) from which a user can select desired input characters, e.g. 221, 222 and 223, by touching the touch screen 217. Before a user starts a selection process, the input characters may be displayed uniformly in an ordinary size. When a user attempts to enter a desired character, he or she may first visually locate the target character, for instance the alphabet letter. Once the finger tip 230 is present within a threshold detectable distance from the touch screen 217, the sensors, e.g. 211, 212 and/or 213, may operate to detect a location of the finger tip 230 relative to the series of input characters in the virtual keyboard. The location signals can be communicated to a processor (not shown) through an I/O interface 216 which comprises an analog/digital convertor 214 and a register 215. Accordingly, the processor is capable of comparing the relative distances between the detected location of the finger tip 230 and each of the input characters in the virtual keyboard 218, and identifies a target character. The processor can execute pertinent commands in the GUI program in response to the identification. Consequently, the on-screen size of the target character is magnified to a larger size from its original size in accordance with embodiments of the present disclosure. Rather than making contact with the enlarged “R” character region, if the finger tip rather moves to another screen region, then another target character will become enlarged.

For example, as illustrated in FIG. 2A by the dashed lines, since the finger tip 230 is most proximate to letter “R” 221, as detected by the sensors, e.g. 211, 212 and/or 213, “R” is identified as the target character the user attempts to enter. In an exemplary embodiment, the enlarged character size is larger than an average finger tip size. The magnification triggered by detection of an approaching finger tip advantageously allows the user to quickly verify the character to be entered and then affirmatively enter the desired character with a reduced risk of inadvertent errors.

Often, a user may not be able to precisely aim his finger tip toward the desired character at the time it initially enters the detectable region above the virtual keyboard. Thus, in some embodiments, as illustrated in FIG. 2A, the characters that are adjacent to the identified target character 211 may be magnified along with the target character as they are also considered probable desired characters. The magnification of more than one character takes into account likely errors and advantageously facilitates the user to locate desired character accurately before an entry is made. For instance, a user wants to input an “E” 222 but his finger tip may be detected to be closet to “R” 221 due to the compactness of the virtual keyboard 218. In this embodiment, “E” 222, as well as a few other characters (not shown) that are adjacent to “R” 221, is also magnified, which allows the user to adjust the moving direction of his finger tip and accurately tap “E” 222. In this situation, “V” may remain in original size as it is determined to be adequately remote from the finger tip and therefore unlikely to be a desired character.

As in the illustrated embodiment in FIG. 2A, the input characters that are proximate to the detected finger tip may be magnified to two or more different size levels depending on their distances from detected finger tip. For example, “E” is magnified to a less degree than “R”. In some other embodiments, a number of characters within a certain distance from a detected finger, including the target character as identified, may be magnified by a same amount. In still some other embodiment, only an identified target character is magnified.

According to the illustrated embodiment in FIG. 2A, the noncontact location sensing mechanism in the computing device includes a set of location sensors, e.g. 211, 212, and 213, disposed in known locations underneath the touch screen 217. During operation, one or more sensors may be able to detect the presence of an approaching finger tip and send location signals to the processor. The detection signals may vary as a function of the distance between the sensor and the finger tip. The processor can determine the location of an approaching tip based on a combination of the location signals. However, in some other embodiments, the sensing mechanism may have only one sensor with a sensing detection region that extends to a whole virtual keyboard area or the whole touch screen area.

For purposes of this disclosure, the location sensing mechanism may be integrated anywhere on a mobile computing device, such as around an edge of the device or underneath the touch screen of the device. In some embodiments, it can be completely enclosed in the housing of the computing device. In some other embodiments, it may be partially exposed to a the outside.

In some embodiments, a user may be able to control the activation or the deactivation of the sensing mechanism, either by a hardware control button or through software. Still, in some embodiments, the sensing detect region may be defined or adjusted by a user, either by a hardware control switch or through software. In this manner, the user can control the threshold distance, or the sensitivity, for magnification.

The input mechanism for purposes of this disclosure can be a finger tip, a passive stylus, an active stylus, or any other type of suitable means that are compatible with the sensing mechanism and the touch screen installed in a specific mobile computing device.

For purposes of implementing this disclosure, any well known touch screens can be use on the mobile computing device. The touch screen can be a resistive touch screen, a capacitive touch screen, an infrared touch screen, or a touch screen based on surface acoustic wave technology, etc.

The technology of the present disclosure is not limited by any particular type of location sensing mechanism and any well known sensor can be used. In some embodiments, the location sensing mechanism may comprise one or more infrared location sensors that are configured to detect the heat or infrared radiation released from an approaching finger tip, stylus, or any other kind of suitable input objects.

In some other embodiments, the location sensing mechanisms may comprise one or more optical sensors. In some of such embodiments, the optical sensors are capable of detecting a shadow of an approaching input object projected on a virtual keyboard. However, the optical sensors in some other embodiments may be configured to detect light emitted from a stylus, for example, equipped with a light-emitting-diode (LED) or any other type of light source.

In some other embodiments, the location sensing mechanism may comprise a magnetic sensor configured to detect a magnetic field emitted from a stylus. In some other embodiments, the magnetic sensors may be configured to actively emit a magnetic field and detect a disturbance of the magnetic field caused by an approaching input object.

In some other embodiments, the location sensing mechanism may comprise an electrical sensor configured to detect an electrical field disturbance caused by an approaching input object or an electrical field emitted from such an object.

Still in some other embodiments, the location sensing mechanism may comprise more than one type of sensors described above.

FIG. 2B illustrates an on-screen GUI 240 displaying selectively magnified input characters, e.g. 231, 232, 233, and 234 in a virtual keyboard 260 in response to detection of an approaching finger 250 in accordance with an embodiment of the present disclosure. As shown, the finger tip 250 is aiming at and most proximate to “R” 231 (without touching), and so “R” 231 is magnified to a size comparable with a finger tip. Also magnified are the characters that surround “R” including “E” 234, “I” 232, and “F” 233. In contrast, further characters, such as “O” 236, remain in the ordinary size. In some embodiments, some characters that are determined to be too remote from the finger tip 250, may diminishes to retain the view of a complete virtual keyboard in the GUI 240, such as “P” 235,

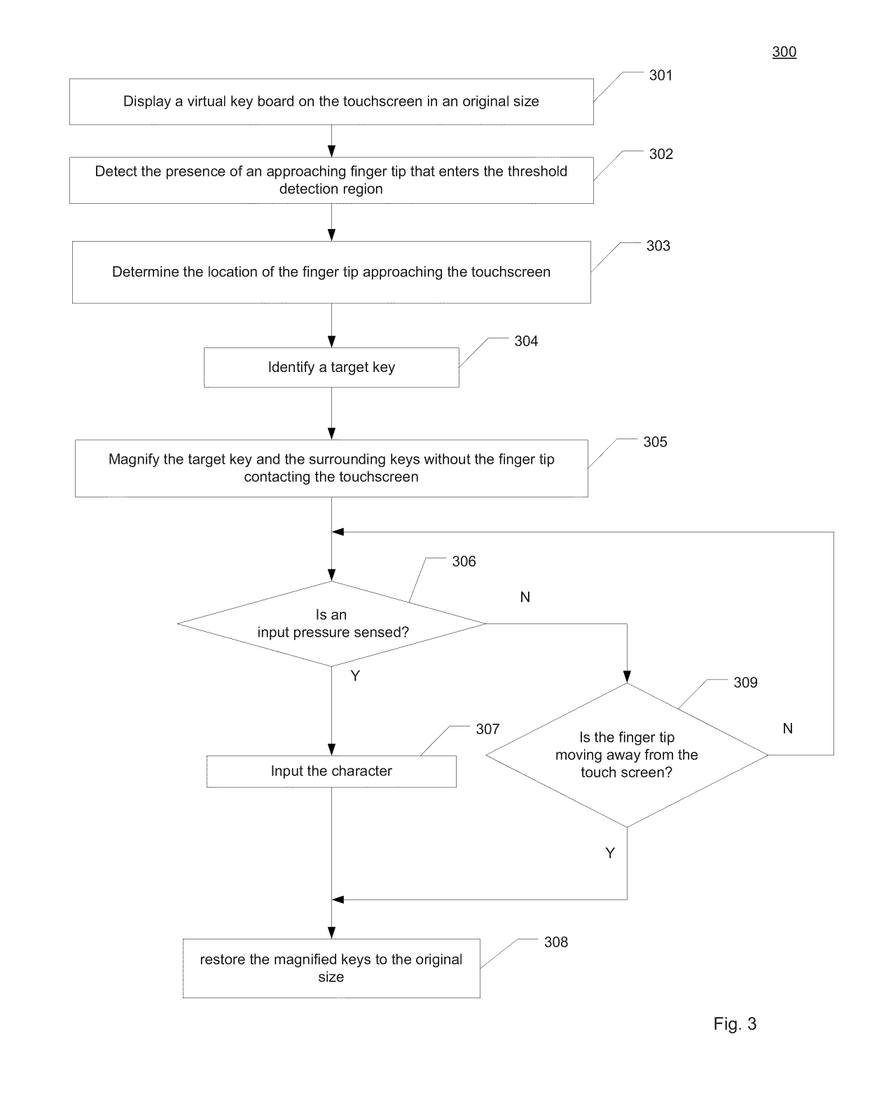

FIG. 3 is a flow diagram depicting an exemplary computer implemented method 300 for entering input characters on an on-screen virtual keyboard in accordance with an embodiment of the present disclosure. At 301, a GUI having a virtual keyboard is displayed on the touch screen where the individual soft keys are displayed in an ordinary size. At 302, an approaching user's finger tip is detected by the location sensors once it enters a threshold detection region, e.g. 20 mm from a sensor. Based on the signals sent from the sensors, the location of the finger tip center is determined at 303, and accordingly a target key is identified at 304. Before the approaching finger contacts the touch screen and enters a character, the target key and a few selected surrounding keys are magnified on screen at 305. Optionally, a few keys that are remote from the target key may shrink from the original size at 305.

If it is determined that an input pressure has been exerted on the touch screen at 306, a character being tapped is entered in an input area of the GUI at 307, regardless which character is identified as the target character. Following the entry of a character, the magnified characters can be restored to the original size at 308.

On the other hand, following the magnification at 305, if an input pressure is not detected at 306, e.g., a selection has not been made, and it is be determined at 309 the input object moves away from the touch screen, the magnified character may restore to the ordinary size at 308, and the above operations may be repeated.

A touch screen in conjunction with a noncontact location sensor to detect an approaching input object in accordance with the present disclosure can be applied in any type of device that employs a display panel, such as a laptop, a cell phone, a personal digital assistance (PDA), a touchpad, a desktop monitor, a game display panel, a TV, a controller panel, etc.

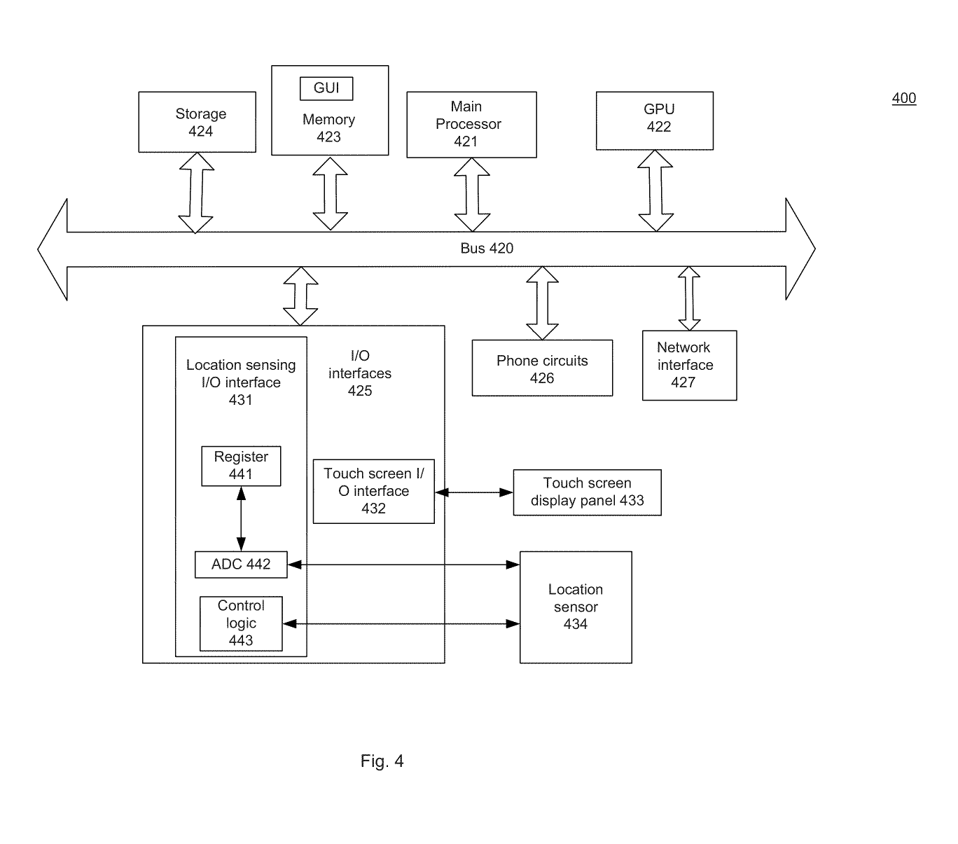

FIG. 4 is a block diagram illustrating an exemplary configuration of a mobile computing device 400 that comprises a noncontact location sensor 434 to facilitate user input on an on-screen virtual keyboard in accordance with an embodiment of the present disclosure. In some embodiments, the mobile computing device 400 can provide computing, communication and/or media play back capability. The mobile computing device 400 can also include other components (not explicitly shown) to provide various enhanced capabilities.

According to the illustrated embodiment in FIG. 4, the computing system 400 comprises a main processor 421, a memory 423, an Graphic Processing Unit (GPU) 422 for processing graphic data, network interface 427, a storage device 424, phone circuits 426, touch screen display panel 433, I/O interfaces 425, and a bus 420, for instance. The I/O interface 425 comprises a location sensing I/O interface 431 and a touch screen I/O interface 432.

The main processor 421 can be implemented as one or more integrated circuits and can control the operation of mobile computing device 400. In some embodiments, the main processor 421 can execute a variety of operating systems and software programs and can maintain multiple concurrently executing programs or processes. The storage device 424 can store user data and application programs to be executed by main processor 421, such as GUI programs, video game programs, personal information data, media play back programs. The storage device 424 can be implemented using disk, flash memory, or any other non-volatile storage medium.

Network or communication interface 427 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 427 can provide wired network connectivity instead of or in addition to a wireless interface. Network interface 427 can be implemented using a combination of hardware, e.g. antennas, modulators/demodulators, encoders/decoders, and other analog/digital signal processing circuits, and software components.

I/O interfaces 425 can provide communication and control between the mobile computing device 400 and the location sensor 434, the touch screen panel 433 and other external I/O devices (not shown), e.g. a computer, an external speaker dock or media playback station, a digital camera, a separate display device, a card reader, a disc drive, in-car entertainment system, a storage device, user input devices or the like. The location sensing I/O interface 431 includes a register 441, ADC 442, control logic 443. The control logic 443 may be able to control the activation or the sensitivity of the location sensor 434. The location signals from the location sensors 434 are converted to digital signals by the ADC 442 and stored in the register 441 before communicated to a processor. The processor 421 can then execute pertinent GUI instructions stored in the memory 423 in accordance with the converted location signals.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computing device comprising:
a processor;
a memory coupled with said processor, said memory operable to store instructions that, when executed, implement a Graphic User Interface (GUI), said GUI comprising a virtual input array that comprises a plurality of input selections arranged in a pattern;
a touch screen panel;
a location sensor coupled with said processor, said location sensor operable to detect presence of an input means upon said input means entering a detectable region proximate to said touch screen panel;
logic operable to determine a location of said input means with respect to said plurality of input selections on said virtual input array, and wherein said GUI is configured to:
identify an intended input selection based on said location of said input means; and
magnifying said intended input selection to a first magnified dimension.

2. The computing device as described in claim 1, wherein the identifying an intended input selection comprises identifying an input selection that is positioned most proximate to a location of said input means among the plurality of input selections in said virtual input array.

3. The computing device as described in claim 1, wherein said GUI is further configured to magnify a plurality of surrounding input selections on said virtual input array to a second magnified dimension, wherein said plurality of surrounding input selections are arranged adjacent to said intended input selection in the virtual input array, and wherein further said first magnified dimension is larger than said second magnified dimension.

4. The computing device as described in claim 2, wherein said location sensor is coupled with control logic that is operable to control activation the sensitivity of said location sensor.

5. The computing device as described in claim 1, wherein said location sensor is a noncontact location sensor and comprises an infrared location sensor and is configured to sense infrared radiation from said input means.

6. The computing device as described in claim 1, wherein said location sensor is a noncontact location sensor and comprises an optical sensor and is configured to detect said input means based on a shadow projected on said touch screen panel.

7. The computing device as described in claim 1, wherein said location sensor is a noncontact location sensor and comprises a magnetic sensor and configured to detect said input means responsive to changes to magnetic field induced by said input means, wherein said input means comprises a magnetic component.

8. The computing device as described in claim 1, wherein said input means is selected from a group consisting of a user finger, a passive stylus, and an active stylus.

9. The computing device as described in claim 1, wherein said detectable region is approximately 20 mm above the touch screen panel.

10. The computing device as described in claim 1, wherein said virtual input array comprises an alphanumeric keyboard layout.

11. The computing device as described in claim 1, wherein said location sensor is further associated with an analog/digital converter and a register.

12. A method of providing input to a computing device through a touch screen panel, said method comprising:
displaying a virtual input region on said touch screen panel in a first size, wherein said virtual input region comprises a plurality of input characters;
detecting presence of a user input object approaching said touch screen panel;
determining distances between said user input object and said plurality of input characters on said virtual input region;
identifying a first character as an intended character responsive to said distances; and
magnifying an on-screen size of said first characters to a first level upon said user input object being within a threshold detectable distance from said touch screen panel.

13. The method as described in claim 12 further comprising:
identifying a first plurality of surrounding characters arranged proximate to said first character in said virtual input region;
magnifying on-screen sizes of said first plurality of surrounding characters to a second level upon said user input object being within the threshold detectable distance from said touch screen panel;
identifying a second plurality of surrounding characters arranged proximate to said first plurality of surrounding characters in said virtual input region;
magnifying on-screen sizes of said second plurality of surrounding characters to a third level,
wherein said first level is greater than said second level and said second level is greater than said third level.

14. The method as described in claim 13 further comprising diminishing on-screen sizes of another plurality of input characters that are arranged distant from said intended character.

15. The method as described in claim 13 further comprising selecting an input character in response to said user input object exerting a pressure on a screen region corresponding to said input character.

16. The method as described in claim 13 further comprising restoring said plurality of input characters to said first size in response to detection that said user input object is moving away from said virtual input region.

17. A mobile computing device comprising:
a processor;
a memory coupled to said processor, said memory operable to store instructions for implementing a Graphic User Interface (GUI) configured to display a virtual keyboard comprising a plurality of input characters arranged in a pattern;
a touch screen display panel;
a distance sensor in association with control logic coupled to said processor, said distance sensor configured to:
detect presence of a user digit proximate to said touch screen display panel as the user digit approaches said touch screen display panel;
wherein said GUI is further configured to:
determine a location of said user digit with respect to said plurality of input characters; and
magnify a set of plurality of input characters that are determined to be proximate to said location of said user digit upon said user digit being within a non-zero detectable distance from said touch screen display panel.

18. The mobile computing device as described in claim 17, wherein said distance sensor comprises a thermal sensor configured to sense the heat associated with a user digit.

19. The mobile computing device as described in claim 17, wherein said set of plurality of input characters are magnified by different amounts, wherein said different amounts are determined based on distances between said user digit and each of said plurality of input characters on said virtual keyboard.

20. The mobile computing device as described in claim 17, wherein said non-zero detectable distance from said touch screen display panel is approximately 25 mm.
